(19) United States
(12) Patent Application Publication
(10) Pub. No.: US 2004/0193545 A1
(43) Pub. Date: Sep. 30, 2004

(54) Method and system for digital licensing distribution

(76) Inventor: Gady Shlasky, Kochav Yair (IL)

Correspondence Address: DARBY & DARBY P.C., P. O. BOX 5257, NEW YORK, NY, 10150-5257, US

(21) Appl. No.: 10/783,952

(22) Filed: Feb. 19, 2004

Related U.S. Application Data
(63) Continuation-in-part of application No. 09/702,047, filed on Oct. 30, 2000.

(51) Int. Cl. G06F 17/60

(52) U.S. Cl. 705/59

(57) ABSTRACT

Digital product manufacturers develop and publish digital products. Prior to product distribution product-specific license patterns and lincense handlers are created. A modified digital product, is generated such that is includes a license handler routine The modified digital product integrated with the license handler module is conveyed independently of the digital license to the customers. Copies of digital licenses are generated utilizing a digital license generator. The licenses are distributed to end-users independently of the digital products. When end-users wish to purchase a license for a digital product, a request is made regarding the supply of a suitable end-user license. License distributors utilize a specifically developed digital license distribution server to generate product-copy-end-user-licenses, and send the end-user licenses to the end-users for installation. During subsequent operations on the end-user's platforms, the digital products purchased by the end-users interact with the digital licenses purchased by the end-users. The interaction is performed through the license handlers integrated with the digital products.

### CROSS-REFERENCE TO RELATED APPLICATIONS

This Application is a Continuation-in-part of application 09/702,047 filed on Oct. 30, 2000.

### BACKGROUND OF THE INVENTION

1. Field of the Invention

The present method and system relates to digital licensing distribution in general, and to a method and system for of the generation of digital product licenses, in particular.

2. Discussion of the Related Art

A digital product license is a document or a set of documents mutually agreed upon by the parties participating in a commercial transaction involving a digital product. The license grants the purchaser a permit to use the product for an agreed upon period of time under terms and conditions predefined by the product manufacturer having a specifically defined licensing policy. As an example, one such usage condition may relate to a limitation in regard of the usage of the product on specific computing platforms only, or to “lock” the licensed product to a particular computer. A digital license provides the digital product manufacturer with a legal instrument against impermissible usage of a licensed product. It is important to note though that traditional software licensing is only a legal mechanism and not a device or means to literally prevent illegal copying of proprietary digital products.

Digital products refer to both executable files such as software programs and to electronic content files such as digitized documents, pictures, video or sound recordings. Conventionally, digital products are distributed on computer-readable media such as a diskette packed within physical packages where the package usually includes product-related printed paper documents such as the user manuals, installation instructions, and standard license agreements. The packages incorporating the packaged digital products and the accompanying documents are then sent through conventional marketing chains employing standard distribution channels such as the services of conventional mail.

As a result of the development and widespread usage of low-priced, high-capacity, and reliable storage media such as compact disks, costly and bulky paper manuals are increasingly being replaced by computer-readable digitized documentation thereby reducing the size of the packages substantially as a result of the bundling of the digital product with associated documentation. Furthermore, with the advent of inexpensive hard disk drives, and ready Internet access, it is now feasible to distribute the products and associated documents electronically. Thus purchasers are allowed to download the digital products from a computer server system such as an e-commerce site or an electronic storefront established and maintained by digital product providers such as a product manufacturer or dealer. A digital manufacturer typically cooperates with one or more dealers, resellers or distributors in order to effectively carry out electronic product distribution. In such an arrangement, the digital product manufacturer supplies saleable products to a number of dealers with the permission to sale much like a merchant wholesaler utilizing the services of merchant retailers.

As a result of the widespread usage of the world wide data communication networks the marketing chain of digital products such as executable files and digital content files is increasingly implemented across communication networks such as the Internet. Although digital products are considered practically the ideal product for electronic marketing and distribution some problems persist. One of the primary problems of electronic distribution relates to the control of digital product licensing. Digital products, unlike concrete, physically fabricated goods, can be very easily duplicated and consequently illegally re-distributed. In order to accomplish businesslike, organized, and systematic distribution of their products accompanied with the appropriate granting of right of use licenses, digital product manufacturers employ software licenses as the primary means of control.

Being aware of the questionable value of digital licenses in themselves against misappropriation most digital product manufacturers introduce some sort of security mechanism into or linked to their products in order to prevent copying or to make the use of the illegally duplicated products difficult. Although the existing protection techniques are complex and substantially increase the development costs, when used in combination with software licensing mechanism security techniques can provide substantial barriers to digital product piracy. Therefore, notwithstanding their arguable practical benefit the best available defense against illegal copying is still software licensing combined with established protection techniques.

At present the management of the digital licenses is still typically conducted via the conventionally printed paper license agreements. Monitoring the use of digital products based on such paper-license agreements is increasingly difficult and to track the movements of media containing specific digital products and associated paper licensing documents is practically impossible. In order to provide for a more flexible and enforceable licensing granting of usage rights licenses to legitimate purchasers of the digital products may be performed digitally, in a format that can be distributed via electronic media. Electronic licensing distribution is known in the art as the creation, transfer, maintenance, and tracking of licenses associated with digital products via a data communication network or other medium. The best known form of electronic licensing is associated with a typical digital product such as software download by a client from an Internet server, which involves the translation of the traditional text version of license terms and conditions into an electronic format that may be verified and established in a dealer's database. A more effective licensing technique employs some form of integrated licensing mechanism, which involves the combining of electronic licensing technology with the original digital product by the digital product developer and distributing separate electronic end-user licenses to the purchasers as they acquire license rights.

The integrated licensing mechanism provides several advantages. The technique provides the ability to protect licenses by disabling electronically distributed material, provides the ability to license the use of a product by any entity in the distribution chain, and substantially reduces the cost of distribution by separating between the distribution of the license from the distribution of the digital product. A licensed product such as a software application with all its features and functionality can be delivered to the purchaser only once. Consequently, through employing flexible licensing options variable purchaser-specific license packages can be tailored. Thus as the software or digital products are distributed only once for any possible combination of the existing features substantial savings in manufacturing, storage and delivery costs could be achieved.

A further advantage relates to combination licensing. Combination licensing refers to a feature of digital licensing through which individual features or components of a digital product can be licensed separately thereby providing a licensed combination of desired product features to the purchaser. The package of combination licensing can be easily modified at any given time to meet individual licensee needs without replacing the referred digital product. Thus a single set of executable files may be used for different versions of the same product as the level of functionality provided to the purchaser can be controlled. Additional advantages of the technique relate to the ease with which various other licensing options can be accomplished independently from the licensed product such as re-licensing, license upgrading and companion licensing operations independently.

Typically, licensing of digital products is performed on a user-by-user basis. Thus licensing may be sanctioned based on the number of physical copies of a digital product purchased by an end-user. An additional advantage of the integrated licensing mechanism is that one physical copy of a digital product can be licensed for use by multiple users. In this case, the number of users, or communication network connections, is not based on the number of physical copies of a digital product. One copy of a digital product to be executed played or performed in a data communication network can be licensed for a certain number of users or connections.

The routine operation of an integrated licensing application should involve substantial security measures. In its electronic format the license is a computer-readable binary file which is routinely transmitted through standard communication devices of an open data communication network to specific computer platforms hosting digital product dealers, resellers, e-commerce sites, and purchasers, utilizing known communication software programs. Not all of these elements are routinely protected against illegal tampering. In order to prevent illegal access to the licenses being transmitted, at each stage of the process, additional complex security measures such as encryption/decryption routines, anti-debugging modules and the like have to be utilized.

Integrated licensing transactions tend to be critical to the operation of both digital product providers and end-users. The effect of a failed licensing transaction may cascade through the entire supply chain of manufacturer-distributor-customer. An erroneous transaction may result in the inability of a customer to use an acquired digital product, may substantially hurt future sales of a manufacture, and may materially damage a distributor. Furthermore, non-secured or unsafe licensing transactions can result in the illicit copying and consequently illegal distribution of licenses thereby causing substantial financial loss to all legitimate parties involved.

At present there exist several prior art systems, which provide integrated licensing solutions for digital product distributors. However, the existing solutions provide license identification through a minimal set of values. One or more unique numbers pre-defined by the product manufacturer and introduced into the license body identifies most electronic licenses supplied to the customers and installed on the user's platforms. Some of the existing solutions utilize pre-set passwords, customer numbers, or product serial numbers. It will be easily perceived that in order to prevent effectively illicit copying and consequent illegal re-distribution the supplied license there is a need for a truly unique and complex license identification pattern. Such an identification pattern is preferably should be unknown and unrecognizable by the legitimate end-user itself. The license identity should be constructed by a set of complex rules. The rules should involve in addition to manufacturer-defined values the utilization of diverse data specific to the customer, to the customer's platform, and to the usage pattern of the digital product. In suitable combination with the information described above the set of rules preferably will have to make use of pseudo random non restorable values and to perform appropriate processing in order to compute an appropriate unique identification structure for the license and thereby prevent or at least substantially minimize illegal utilization of the product.

### SUMMARY OF THE PRESENT INVENTION

One aspect of the present invention regards a system for digital license generation. The system comprises the elements of: a license pattern generator for creating at least one license pattern structured in accordance with the characteristics of an at least one digital product and for creating an at least one license handler module structured in accordance with the at least one license pattern and with the at least one digital product, a digital product modifier for integrating the at least one license handler module into the at least one digital product, and at least one modified digital product comprising the at least one digital product integrated with the at least one license handler module.

A second aspect of the present invention regards a a method for digital license generation. Thee method comprises the steps of: generating an at least one digital product-specific license pattern to be used for the creation of an at least one digital license, creating an at least one license handler module structured in accordance with the characteristics of a digital product and with the product-specific license pattern, modifying an at least one digital product by integrating an at least one license handler module with the at least one digital product, and conveying an at least one modified digital product integrated with the at least one license handler module to a customer independently of a digital license.

### BRIEF DESCRIPTION OF THE DRAWINGS

The present invention will be understood and appreciated more fully from the following detailed description taken in conjunction with the drawings in which:

FIG. 1 is a block diagram illustrating the system and the various operative entities thereof, according to a preferred embodiment of the present invention;

FIG. 2 is a block diagram illustrative of an overview of the proposed method, in accordance with a preferred embodiment of the present invention;

FIG. 3 is a block diagram illustrating the structure of the Digital License Distribution Server according to a preferred embodiment of the present invention;

FIG. 4A is a diagram illustrating the prior art licensing scheme;

FIG. 4B is a diagram illustrating the licensing scheme of the present invention; and

FIG. 5 is a flow chart of the licensing operation performed by the Digital license distribution server, in accordance with a preferred embodiment of the present invention.

### DETAILED DESCRIPTION OF THE PREFERRED EMBODIMENT

A method and system for digital product generation is disclosed. In the preferred embodiment of the present invention the digital license formed by a digital licensing system. The digital licensing system is employed for the creation, extraction, transmittal and management of right-to-use software licenses associated with the licensed digital products. However, it will be clear to those who are skilled in the art that in other embodiments of the present invention the proposed system and method could be used for the creation, extraction, transmittal and management of diverse other digital products such as software applications, multimedia files, e-coupons, e-vouchers and the like.

The objectives of the proposed method and system are accomplished in the following manner. Digital product manufacturers develop and publish digital products such as software applications or rich media files. When wishing to license their products the manufacturers create product-specific license pattern by using license pattern generator software. The generator outputs a modified digital product, which includes license handler routines and a product-specific license pattern. The modified digital product is conveyed independently of the license to requesting customers along various distribution channels. The distribution chain could include digital product distributors, resellers, e-merchants, or other dealers. The products could also be transferred to the end-users directly from the manufacturers. In order to prevent fully functional utilization before the end-user's acquirement of suitable usage licenses the supplied products could be partially or entirely disabled regarding usage by the customer, For example, the products supplied could be enabled for demonstration purposes only or could be having certain advanced features suitably blocked. The end-users could evaluate the partially disabled product copy and consequently could make decisions concerning the desired features and usage options for the performance of the product. In order to activate and utilize the product in the desired manner the end-user has to acquire a usage license. Thus, the license pattern provide usage rules enabling or limiting specific usage of the digital product.

Digital product manufacturers create copies of digital licenses utilizing a digital license generator application having as input a product-specific license pattern. The licenses thus generated are distributed independently of the product among the digital product distributors. When end-users or customers wish to purchase a license for an evaluated product, a request is made to the digital product distributor regarding the supply of a suitable license. The distributors utilize a specifically developed digital license distribution server application to generate product-copy-end-user-license, and send the end-user license to the purchaser for installation. Each created end-user license is unique as the digital license distribution server creates a unique fingerprint for each separate end-user license using customer-specific data combined with randomly determined values. When a product received by the customer is activated the embedded license handling routines interact with the purchased product-copy-specific end-user license in order to enable or disable specific utilization of the product depending on the type, the pattern, and the fingerprint of the end-user license.

The distributors could trade with licenses among themselves by transmitting a set of digital licenses to another distributor by request. If a request for a license from a purchaser can not be satisfied the distributor could direct the purchaser to another distributor having the appropriate digital license or alternatively could acquire a suitable license from another distributor himself and supply the license to the requesting purchaser. Thus the trade in licenses is managed not only between manufacturers, and distributors, but also among the distributors themselves. The manufacturer also could function as a dealer of his own products and licenses. By utilizing the digital licensing distribution server application the manufacturer could create, store, maintain and distribute his own licenses to customers or could trade the licenses to other distributors along the marketing chain.

It will be understood that while the invention is described for one specific embodiment which is a digital licensing distribution system in other embodiments of the present invention the proposed system and method could be used for the transferal and distribution of other diverse digital products such as e-coupons, and e-vouchers. E-vouchers and e-coupons are electronic licenses that contain encoded rules such as redemption time, discount percentage and the like.

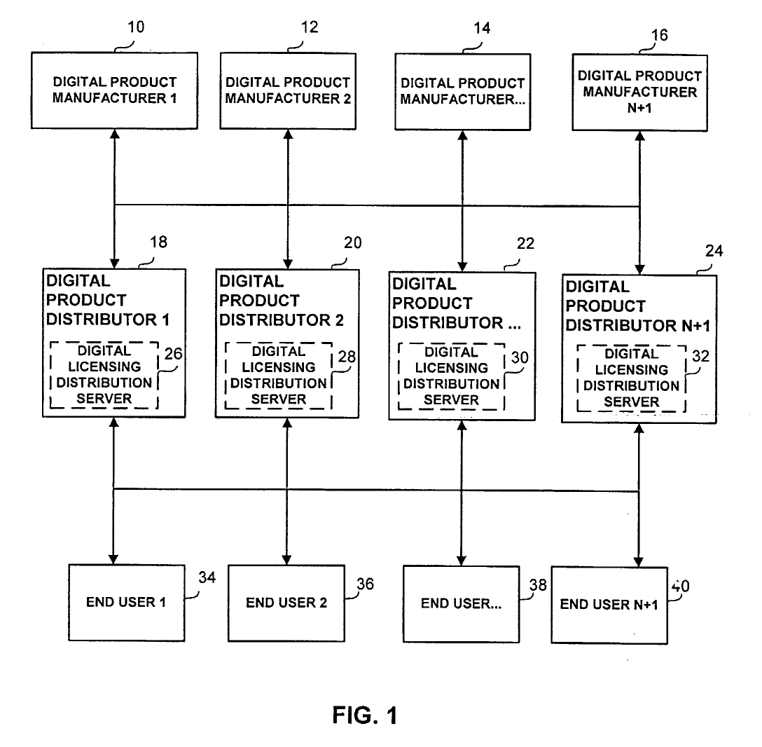

Referring now to FIG. 1 illustrating an exemplary computing and communication environment within which a preferred embodiment of the present invention is operative. A plurality of digital product manufacturers 10,12,14,16 operate server systems embedded on computing platforms within a data communication network. The computing platforms could be main frame computers, personal computers, and the like. The platforms could be coupled to a data communication network, such as the Internet, to a Local Area Network (LAN), a Wide Area network (WAN), a traditional telephone network, a cellular telephone network, a satellite based communication network, and the like. Manufacturers 10,12,14,16 could be independent software application developers, digital content packagers, digital license distributors, digital record companies, digital video distributors, computer game developers, electronic publishers and the like. The manufacturers 10,12,14,16 are communicatively connected via standard wired, wireless or cellular communication devices to a plurality of digital product distributors 18,20,22,24. Distributors 18,20,22,24 run server systems embedded on computing platforms across a data communication network. Distributors 18,20,22,24 could be e-merchants running e-commerce applications involving electronic shop-fronts where the merchandise sold includes diverse digital products, and associated digital licenses. Distributors 18,20,22,24 could also be conventional dealers or resellers of digital products operating a digital product distribution site across the data network. A plurality of end-users or customers 34,36,38,40 are intermittently linked via standard wired, wireless or cellular communication devices to distributors 18,20,22,24. End-users 34,36,38,40 run client systems implemented on computing platforms across the a communication network. The communication network could be a data communication network, such as a Wide Area network (WAN), a Local Area Network (LAN), and the like. The network could further be a traditional telephone network, a cellular telephone network, a satellite network, and the like. The end-users 34,36,38,40 could be diverse entities such as large commercial companies utilizing digital products such as software application for the effective running of their business, private users wishing to play computer games, or any other entity with a potential for the purchase of diverse digital products. End-users 34,36,38,40 initiate communication sessions via wired, wireless or cellular communication devices with distributors 18,20,22,24 and optionally with manufacturers 10,12,14,16 in order to perform on-line purchases of diverse digital products. Distributors 18,20,22,24 interact with end-users 34,36,38,40 in order to accept and process orders for the digital products and to enable electronic transfer of the products to the buyers. Independently of the movement of the digital product manufacturers distributors 18,20,22,24 initiate communicative sessions via wired, wireless or cellular communication devices with manufacturers 10,12,14,16 in order to place requests for one or more of digital licenses to be delivered to end-users 34,36,38,40 or to be traded to other distributors 18,20,22,24. End-users 34,36,38,40 initiate communicative sessions with distributors 18,20,22,24 in order to place requests for the purchase of licenses necessary for the activation and utilization of received digital products. Distributors 18,20,22,24 interact with end-users 34,36,38,40 in order to receive the customer's unique “fingerprint” constituted of a set of parameters such as user platform-specific data, requested usage pattern and the like. The fingerprint thus extracted is utilized in the process of the forming of unique end-user license. It is important to note that digital product distributors 18, 20, 22, 24 could connect among themselves communicatively in order to provide the option of suitable inter-dealer trade in digital licenses.

It will be further understood that the participants described in the context of the preferred embodiment could be different in other contemplated embodiments of the present invention. In other embodiments the digital products transferred and distributed through the proposed system could be e-coupons and e-vouchers. Consequently the participants connected to the system could include various vendors supplying value-added services to customers. The communication network through which the various computing platforms are connected could be a data communication network, such as the Internet, a traditional telephone network, a cellular telephone network, a satellite network, and the like. The computing platforms could include mainframe computers, personal computers, laptop computers, personal digital devices, “smart phones”, cellular phones, and the like.

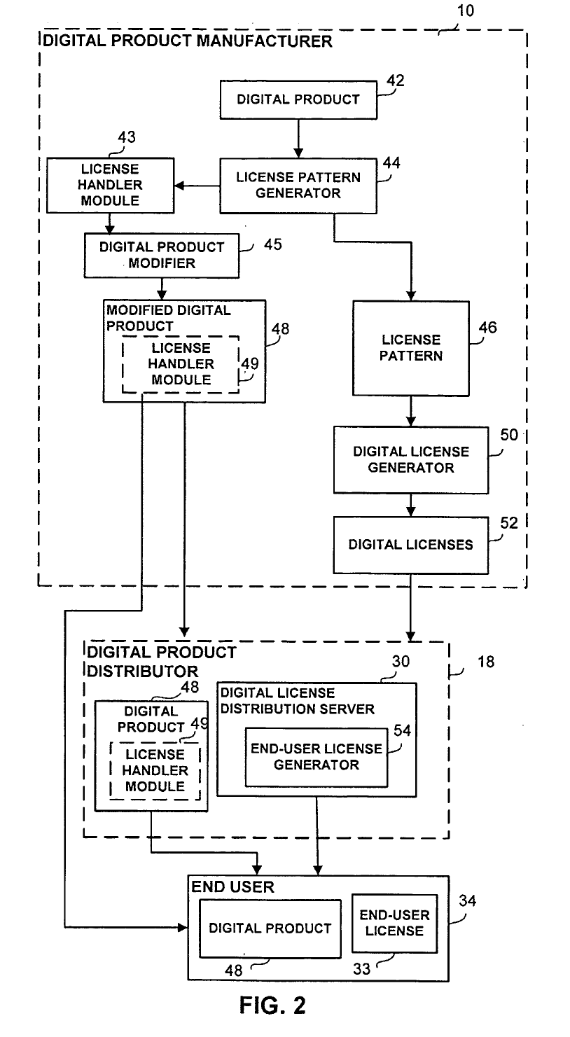

Referring now to FIG. 2 illustrative of an overview of the proposed method, in accordance with a preferred embodiment of the present invention. Digital manufacturer 10 generates a license handler module 43 and associated license pattern 46 by employing license pattern generator 44. The license pattern 46 is structured in accordance with the characteristics of a digital product. The license handler module 43 is structured in accordance with the characteristics of the digital product and the license pattern 46. Digital product modifier 45 utilizes digital product 42 and license handler module 43 as inputs in order to form a modified digital product 48. The modified digital product 48 includes the original digital product 42 and the license handler module 43. Digital product 48 when delivered to a customer's machine and activated therein will attempt to interact via license handler module 49 with an end-user license created within the distribution chain based on license pattern 46 and delivered to the customer's machine independently. Thereby modified digital product 48 is provided with the capability independently handling license-related procedures. Thus, the loading and activation of digital product 48 will first effect the execution of the license handler module 49 integrated therewith. The module 49 is responsible for locating of an end-user license 34 associated with the digital product 48. The module 49 further responsible for will suitably verifying the license 34 by checking the relevant information embedded in the license 34, such as an expiration date, and the like. If the license 34 is non-existent, non-operative or non-valid then the module 49 will effect termination of the running of the product 48 until a valid license 34 will be properly acquired. In addition, the module 49 could further notify the end user regarding the state of the product licensing and could direct the end user to purchase a license or to renew an expired license.

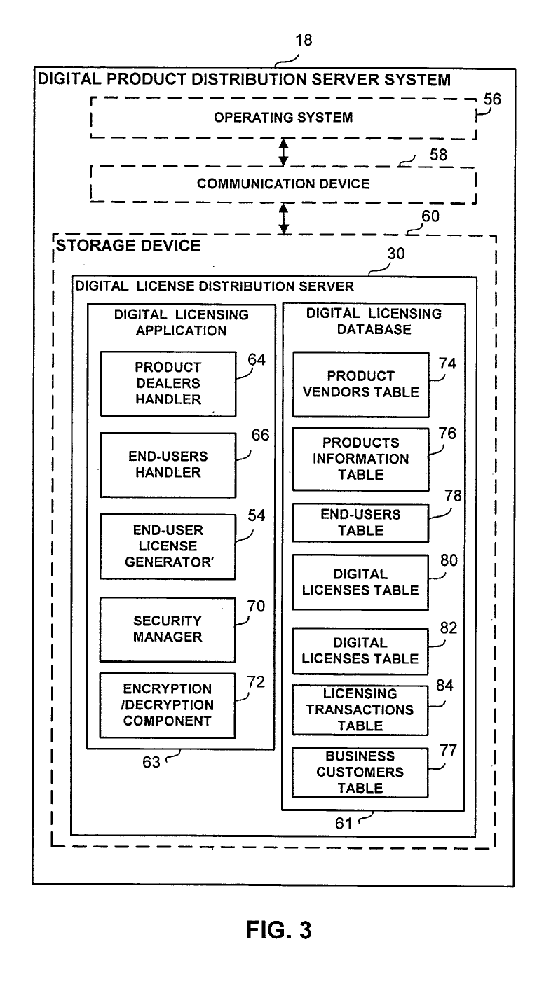

Manufacturer 10 generates copies of digital licenses 52 by employing digital license generator 50. Generator 50 utilizes product-specific license pattern 46 as input and creates a set of product-specific digital licenses 52 based on license pattern 46. Licenses 52 are distributed among digital product distributors 18,20,22,24 of FIG. 1 following requests from the distributors. Digital licenses 52 are a tradable commodity. Digital licenses 52 could be traded among the middle-tiered level of entities in the marketing chain. Typically digital licenses 52 are stored by the distributor 18 for future use. Digital licenses 52 could also be stored by digital product manufacturer 10. When end-user 34 wishes to purchase a license a connection is made to digital product distributor 18 and end-user 34 introduces a suitable request for the licensing of delivered digital product 48. Following end-user 34 request digital product distributor 18 activates digital license distribution server 30 of FIG. 3 embedded on the distributor 18 server computer machine. Digital license distribution server 30 is a specifically developed software application for the creation, installation, updating, storage and tracking of electronic end-user license. Server 30 is implemented to provide suitable interaction with end-user 34 subsequent to the demands for licensing and prior to the end-user license creation. End-User License generator 54 is implemented in digital license distribution server 30 to provide the creation of a unique end-user license to be used in association with the supplied modified digital product.

It is important to note that the present invention could be applied for the distribution of diverse other digital product. A presently contemplated embodiment is the processing, transferal and distribution of e-coupons and e-vouchers.

Referring now to FIG. 3 illustrating components of the digital product distributor platform 18 operative in the running of the proposed system and method. Distributor 18 consists of an operating system 56, a communication device 58 and a storage device 60. Storage device 60 is typically a hard disk. Device 60 comprises a digital license distribution server 30. Server 30 comprises digital licensing application 63 and digital licensing database 61. Digital license distribution application 63 comprises product dealer's handler 64, end-users handler 66, end-user license generator 54, security manager 70, and encryption/decryption component 72. Database 61 contains product vendors table 74, products information table 76, business customers table 77, end-users table 78, manufacturing licenses table 80, digital licenses table, and licensing transactions table 84.

Digital Licensing Application 63 is a specifically developed software application implemented within digital license or product distribution server 30, which is embedded on a computer platform in a data communication network. Server 62 is operated in the environment of the operating system 56. Operating system 56 could be any of the known operating systems supporting operations in a data communication environment such as Microsoft Windows NT, Windows 98, Unix, Linux, and the like. Digital product distribution server system 18 is communicatively connected to diverse other server systems hosting product manufacturers, product distributors, resellers, e-merchants, and other similar product vendors. Server system 18 is also communicatively linked to client systems operated by end-users. The communication among the various systems embedded on computing platforms across the data communication network is accomplished by suitable communication mechanisms such as communication device 58. Device 58 could be a modem or a network interface card. In the preferred embodiment of the present invention digital licensing application 63 is operative in the creation, transfer, and maintenance of software licenses via a data communication network such as the Internet or any other communication channel. The functionality of the various components constituting application 63 will be described next. Application 63 interacts with digital product providers such as other distributors via product dealer handler 64. Handler 64 responsible for requesting and receiving digital licenses from product manufacturers 10,12,14,16 of FIG. 1. Handler 64 is also operative in the inter-dealer trade of the digital licenses by requesting, receiving and sending the suitable digital licenses 52 of FIG. 2 to distributors 18,20,22,24 of FIG. 1. End-user handler 66 utilized as the interface to the customers 34,26,28,40 of FIG. 1. Handler 66 responds to customer's requests for digital licenses 52 of FIG. 2, interacts with requesting customers in order to collect data for the customer-specific fingerprint such as customer-platform-specific parameters, product-usage parameters and the like. Handler 66 also responsible for the passing of the collected information to the end-user license generator 54. After the creation of the unique end-user license 34 of FIG. 2 handler 66 will appropriately activate transmission modules to transfer the completed unique end-user license 34 of FIG. 2 to the customer's machine. End-user license generator 54 receives the customer's fingerprint data from end-user handler 66 and generates a unique license utilizing information received from the end-user such as product identification, number of users, licensing period, and the like. Generator 54 will utilize products information table, During the end-user license generation process security manager 70 is activated by end-user license generator 54 in order to identify and/or prevent illegal access to the system elements. The encryption/decryption component 72 is also suitably activated by the end-user license generator 54 in order to optionally encrypt/decrypt the end-user license at various levels of the licensing process as an additional protection against illicit copying or deliberate corruption.

The various tables of digital licensing database 61 will be described next. Product vendors table 76 holds the list of the registered digital vendors from which the server can purchase licenses. End-users table 78 stores the records of registered customers or end-users that performed licensing transactions through application 30. Products information table 76 holds product-specific information such as product identification, distributor, and manufacturer. First digital licenses table 80 stores the original product-specific digital licenses delivered by the product manufacturers. First digital licenses table 80 is used as input to the end-user license generator component 68 to enable creation of product-copy-specific end-user licenses. Second digital license table 82 holds the copies of product-copy-specific end-user licenses created license generator 54 responding to requests of the end-users. Licensing transactions table 84 holds the descriptive records of the appropriate licensing-related transactions such as receiving a digital license from a manufacturer, trading a digital license to another distributor, creating digital end-user licenses, delivery of the end-user license to the requesting end-user, installation of the end-user license on the end-user's machine, notification of the manufacturer of the completion of product licensing, and the like. Licensing transactions table 84 functions as a trace to the activities performed by the digital licensing application 63. Through the utilization of the various tables digital licensing database 61 provides improved monitoring and tracking capabilities regarding the distribution of digital products and associated digital licenses.

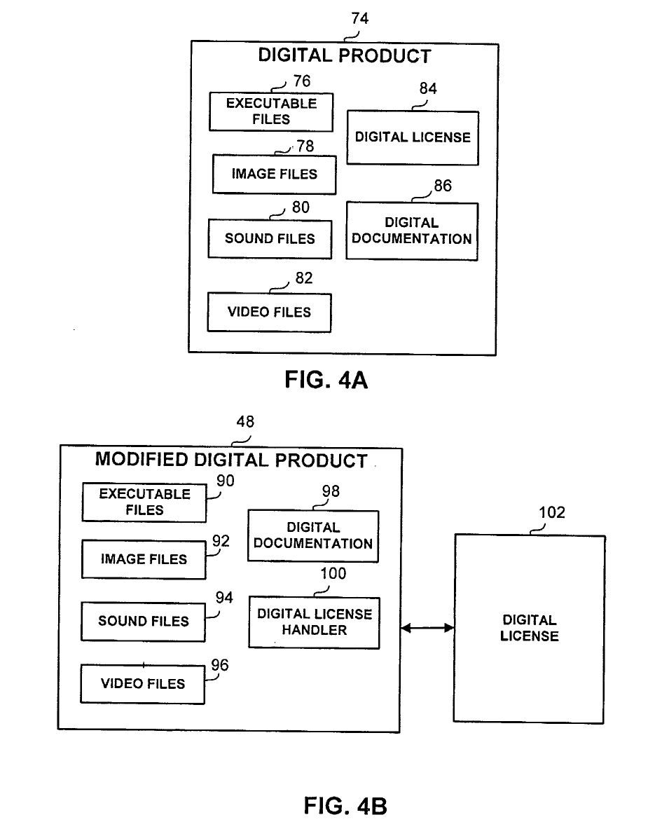

Referring to FIG. 4A illustrating a known exemplary licensing scheme as known in the art. Digital product 74 is an electronic package containing a set of related binary files. Product 74 is in a machine-readable format comprising executable files 76, and diverse multimedia content files such as image content files 78, sound content files 80, and video content files 82. In addition digital product 74 contains digital documentation content file 86 and digital license content file 84. Digital product 74 contains all the elements of an exemplary purchasable digital product. In addition to the executables and to the multimedia content files the product 74 also carries documentation content files 86. Product 74 also contains a digital license file 84. The license 84 is saved on media with product 74 suitably encoded into a machine-readable format in a similar manner to the other files in the product package. When product 74 is purchased the entire set of the components constituting the product 74 are moved via the selected delivery channels. It is important to note that as the license is designed to closely accompany the product right to the targeted customer, the license should be fixedly introduced or “burned” by the product manufacturer into the digital product package. As a result the processing of the license file is substantially limited and the flexible fitting the license options to the requirements of a specific customer related to the different product features is unduly difficult. Although it is possible to minimally fit the license to the customer by a prearranged procedure of user registration, which contributes to the recording of the distributed product-license combination into a product provider-specific database, no sufficient alternatives exist for more sophisticated license pattern processing. Thus using the above-described method of delivery it is relatively easy to illicitly copy the product-license and re-distribute it. When delivering the product license within or alongside the product package practically no options exist for monitoring product usage, or tracking individual product licenses in order to expose and/or prevent non-authorized distribution. It will be easily perceived from the foregoing that the delivery of the product license alongside the digital product has serious disadvantages relating to security, flexibility of licensing, manufacturing and shipping costs, and product usage monitoring.

In contrast FIG. 4B illustrates the proposed licensing scheme, in accordance with a preferred embodiment of the present invention. In the shown scheme digital license 102 is detached from the digital product 48. Product 48 is created, packaged, and delivered in substantially the same manner as the corresponding digital product 74 of the prior art licensing system illustrated on FIG. 4A. Product 48 contains executable files 90, image content files 92, sound content files 94, video content files 96, digital documentation 98, and digital license handler 100. Digital license handler 100 is equivalent to license handler module 49 of FIG. 2. Digital license handler 100 provides the logical link between the product 48 and the separate end-user license 102. The digital license file 102 is created independently, purchased separately, processed in a different manner and distributed along different transmission channels. A logical connection between the digital license 102 and the licensable digital product 48 is formed only at the last stage of the processing thereby providing a unique digital license to each separately purchased digital product 48. The above mentioned advantage is only one out of a series of substantial benefits provided to the legitimate participants of the system by the physical separation the digital license 102 from the other components of the packaged product complex. A detailed description of the operation regarding the substantially independent or semi-independent processing, manipulation, and distribution of digital product 48 and the associated digital end-user license 102 will be set forth hereunder in conjunction with the appropriate drawings.

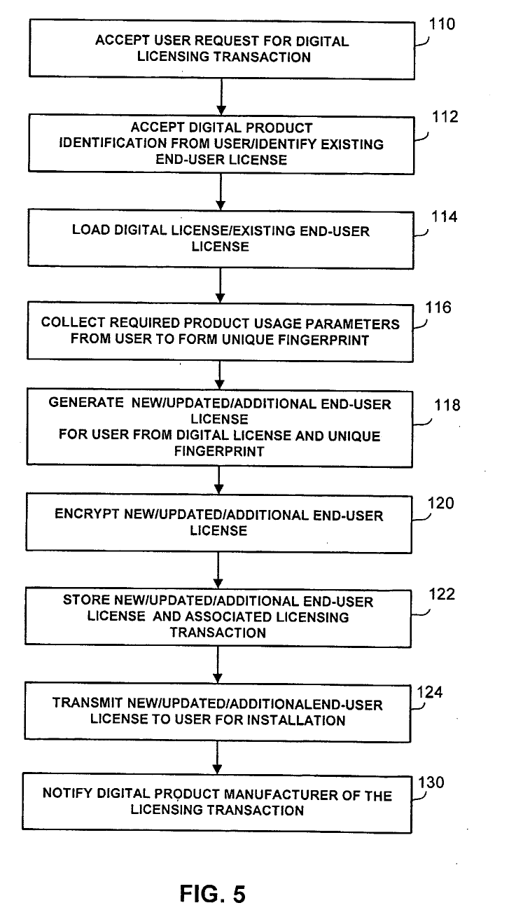

Referring now to FIG. 5 illustrating the operative steps performed by the digital license distribution application during a customer-initiated digital licensing process. At step 110 the application accepts a request from an end-user 34 of FIG. 2 for a digital product-related licensing transaction. The requested transaction could be one of several types such as the generation of a new end-user license 33 of FIG. 2 for digital product 48 of FIG. 2 previously received by the end-user 34 of FIG. 2. Other types of licensing transactions could involve renewal of an existing end-user license i.e., the granting of permission to use a digital product for an additional period of time, the extension of the end-user license such as granting the right to utilize the product by an additional number of users, the updating of an existing end-user license in order to obtain permission to utilize extra features of the product not previously used and the like. Different licensing transactions may involve different steps in the licensing process. At step 112 the identification of the relevant digital product is accepted from the end-user 34 of FIG. 2. If the licensing transaction involves an existing license then the existing license is appropriately identified. The digital product identification is accomplished preferably through the reading of a code previously delivered by the manufacturer supplying the digital product and stored in the products information table 76 of FIG. 3. As the identification code is preferably also embedded within the purchased digital product an orderly identification of the product is achieved. Consequent to the acquiring of the identifying code, at step 114 the application loads the digital license from the first digital licenses table 80 of FIG. 3. If the transaction involves an existing end-user license then the end-user license is loaded from the second digital licenses table 82 of FIG. 3. At step 116 a set of digital license-related parameters are requested and accepted from the end-user. The parameters are used for the unique generation of a digital end-user license for the specific product-copy sold and delivered to the requesting end-user. The set of collectable parameters constitutes a unique fingerprint of the customer platform in combination with the requested license usage pattern. The fingerprint could comprise of the diverse hardware device identifications such as the customer's computer platform processor number, the hard disk serial number and the like. The application responds to the received unique fingerprint by processing suitably the received parameter values, superimposing on the processed values a set of random numbers and creating key values utilizing a pre-defined encoding routine. The values thus formed are used as input to the end-user license generator 54 of FIG. 3. At step 96 the end-user license generator 54 of FIG. 3 generates a unique end-user license utilizing as input the specific digital license for the product, the set of values based on the product information data, user identification data, target platform identification data and optionally other randomly created values.

The generation of the end-user license involves the wrapping of the digital license associated with the digital product with code segments uniquely identifying the product copy sent to the requesting end-user. At step 120 the end-user license or predefined parts of the end-user license are optionally encrypted. At step 122 the end-user license is stored into the second digital license table 82, and a licensing transaction record is stored into licensing transactions table 84 of FIG. 3, Subsequently at step 124 the end-user license is transmitted to the requesting end-user for installation. At step 130 the manufacturer is suitably notified of the completed licensing transaction and the terms thereof. Such terms and rules include the licensor, the terms of the license provided, the product identification information, the date and time of the transaction, and the like.

It will be clear to those skilled in the art that the preceding description, which includes distinct steps and specific components, is exemplary only and in no way intended as limiting. Other steps could be added to the above-described flow of operations and other elements could be used to substantially achieve the objectives of the present invention. The system described could be applied for the distribution of diverse other digital products such as e-coupons and e-vouchers. The foregoing text is set forth in order to provide a ready understanding of the proposed method and system and only the attached claims will define the limits of the present invention.

While an embodiment and an application of the present invention has been shown and described persons skilled in the art will appreciate that the present invention is not limited to what has been particularly shown and described hereinabove. Rather the scope of the present invention is defined only by the claims which follow.

What is claimed as new and desired to be protected by Letters Patent of the United States is:

1. A system for digital license generation, the system comprising:
a license pattern generator for creating at least one license pattern structured in accordance with the characteristics of an at least one digital product and for creating an at least one license handler module structured in accordance with the at least one license pattern and with the at least one digital product;
a digital product modifier for integrating the at least one license handler module into the at least one digital product; and
at least one modified digital product comprising the at least one digital product integrated with the at least one license handler module.

2. The system of claim 1 further comprises:
a digital license generator to generate an at least one digital license from the at least one license pattern; and
a digital license distribution server for receiving the at least one digital license and the at least one modified digital product integrated with the at least one license handler, for generating at least one unique digital product copy license based on the at least one digital license and for sending the at least one unique digital product copy license in response to a customer request for installation.

3. The system of claim 1, wherein the modified digital product comprises:
an at least one executable file for performing the functionality of the digital product; and
a digital license handler to handle licensing functions during the execution of the at least one executable file;
thereby enabling independent self-enabled real-time licensing functionality to the digital product

4. The system of claim 3 wherein the modified digital product comprises an at least one image file, or an at least one sound file or an at least one video file or an at least one document file or an at least one digital documentation file.

5. The system of claim 1 further comprises the elements of:
at least one digital product manufacturer server communicatively connected to the digital license distribution server;
an at least one end-user computing platform communicatively connected to the digital license distribution server; and
the digital license distribution server communicatively connected to a second digital license server.

6. The system of claim 1 wherein the digital license distribution server comprises the elements of:
a digital licensing application to generate at least one unique digital product copy license in response to a request from a customer; and
a digital licensing database to store information associated with the generation of the at least one unique digital product copy license.

7. The system of claim 6 wherein the digital licensing application comprises the elements of:
a product dealer handler for handling digital licenses and modified digital products;
an end user handler for collecting end-user-specific information, computing platform-specific information, and the identification of the digital product installed on the computing platform; and
an end-user license generator for creating an at least one unique digital product specific license for the requesting end-user.

8. A method for digital license generation, the method comprising the steps of:
generating an at least one digital product-specific license pattern to be used for the creation of an at least one digital license;
creating an at least one license handler module structured in accordance with the characteristics of a digital product and with the product-specific license pattern;
modifying an at least one digital product by integrating an at least one license handler module with the at least one digital product; and
conveying an at least one modified digital product integrated with the at least one license handler module to a customer independently of a digital license.

9. The method of claim 8 further comprises the steps of:
building an at least one digital license for distribution based on the digital product-specific license pattern;
generating an at least one unique digital product copy license in response to a request for the unique digital product copy license from a customer; and
sending the at least one unique digital product copy license to the requesting customer for installation for enabling the operation of the modified digital product.

10. The method of claim 8 whereby the step of conveying further comprises the step of disabling specific operational options provided by the digital product conveyed to the customer.

11. The method of claim 10 whereby the step of disabling specific operational options provided by the digital product conveyed to a customer allows for limited utilization of the digital product.

12. The method of claim 8 further comprises the step of sending digital licenses to a digital license distributor server associated with a digital product distributor.

13. The method of claim 8 further comprises the step of identifying an end user unique identification.

14. The method of claim 8 further comprises initiating a communication session with at least one digital product manufacturer for submitting at least one request for at least one digital license.

15. The method of claim 8 further comprises notifying a digital product manufacturer of the digital product and the associated unique digital product copy license of the completion of the licensing transaction.

16. The method of claim 15 wherein the step of notifying further comprises providing detailed user-specific, computing platform-specific, digital product-specific and unique digital product copy license-specific information associated with the completed licensing transaction.

17. The system of claim 1, wherein the digital product is a software application.

18. The system of claim 1, wherein the digital product is an audio file.

19. The system of claim 1, wherein the digital product is an electronic document.

20. The system of claim 1, wherein the digital product is an e-coupon.
